(19) United States
(12) Patent Application Publication
(10) Pub. No.: US 2002/0146576 A1
(43) Pub. Date: Oct. 10, 2002

(54) Treatment of metal substrata with (per) fluoropolyether compounds

(75) Inventors: Mattia De Dominicis, Padova (IT); Gabriella Carignano, Milano (IT)

Correspondence Address: ARENT FOX KINTNER PLOTKIN & KAHN, PLLC, Suite 600, 1050 Connecticut Avenue, N.W., Washington, DC, 20036-5339, US

(73) Assignee: Ausimont S.p.A.

(21) Appl. No.: 10/062,415

(22) Filed: Feb. 5, 2002

(30) Foreign Application Priority Data
Feb. 8, 2001 (IT) MI2001 A 000251

(51) Int. Cl. B32B 15/04

(52) U.S. Cl. 428/450; 428/446; 428/411.1; 428/447

(57) ABSTRACT

Use in the treatment of metal substrata and their alloys, of mono- and bifunctional (per)fluoropolyether compounds having the following structures:

[R_{f}—CFY—L—O]ₘP(O)(O⁻Z⁺)₃₋ₘ (A)

(O⁻Z⁺)₂P(O)[O—L—YFC—O—R_{f}—CFY—L—O—P(O)(O⁻Z⁺)]_{m′}—[O—L—YFC—O—R_{f}—CFY—L—O]P(O)(O⁻Z⁺)₂ (B)

R_{f}—CFY—L—W (C)

W—L—YFC—O—R_{f}—CFY—L—W (D)

wherein: m′=0-20; n=0-8; q=1-8; L is an organic group selected from —CH₂—(OCH₂CH₂)ₙ—, —CO—NR′—(CH₂)_{q}—, with R′=H or C₁-C₄ alkyl;

Z=H, alkaline metal or NR₄ group with R=H or C₁-C₄ alkyl;

Y=F, CF₃; m=1, 2, 3, preferably 1, 2;

W is a group —Si(R₁)_{α}(OR₂)_{3-α} with α=0, 1, 2, R₁ and R₂ equal to or different from each other are C₁-C₆ alkyl groups optionally containing one or more ether O, C₆-C₁₀ aryl groups, C₇-C₁₂ alkyl-aryl or aryl-alkyl groups;

Rf is a perfluoropolyether chain comprising the following units: (CFXO), (CF₂CF₂O), (CF₂CF₂CF₂O), (CF₂CF₂CF₂CF₂O), (CR₄R₅CF₂CF₂O), (CF(CF₃)CF₂O), (CF₂CF(CF₃)O).

The present invention relates to the use of compounds for the treatment of metal substrata or their alloys to confer anti-calcar properties.

Specifically the invention relates to the application on metal surfaces of specific (per)fluoropolyether compounds able to confer anti-calcar properties.

The technical problem to be solved is to minimize the calcar deposition on metal surfaces or to allow an easy removal of the calcar deposited on metal surfaces, without substantially changing the metal coating and allowing the metal to perform with the maximum efficiency, for example in the case of heat exchangers. The metal surfaces treated with the compounds of the invention, maintain the anti-calcar properties in the time, even after a high number of deposition and removal cycles of calcar. With easy removal of calcar it is meant that this last can be removed by a simple washing carried out with a running water flow at room temperature.

It is known that the hot water flowing in the internal pipes of heat exchangers, tends to deposit calcar. The calcar deposited on the pipe metal surface tends to form an internal layer which in the time hinders more and more the water flow increasing the load losses. Besides, the calcar deposit strongly limits the thermal exchange between the heat source outside the pipe and the water inside the pipe.

To remove the calcar deposited on metal surfaces, commercial diluted acid formulations are commonly used which allow to dissolve the calcar. Such chemical treatment has the drawback to be aggressive towards the metal surfaces since it performs as corrosion promoter. Therefore, after a limited number of these treatments, the metal equipment must be substituted. Besides, said treatment can be used for a limited number of times since owing to the corrosion, metal oxide particles form, which are washed. For example in the case of heat exchangers or pipes, said phenomenon implies a pollution of flowing fluids.

Alternatively, to eliminate the calcar deposited, when the mechanical equipment allows it, abrasive systems, such as for example brushes or capture systems can be used to avoid the deposition of solid substances inside metal heat exchangers.

In U.S. Pat. No. 4,489,776 mechanical elements for the cleaning of heat exchangers and to remove the solid substances deposited inside pipes are described. The cleaning system is formed by capture points placed at the ends of the pipes and by brushes which move inside the pipes. Such cleaning system shows the drawback to cause abrasion of the metal itself and besides to need a periodic maintenance.

U.S. Pat. No. 4,383,346 relates to cleaning elements using a rotating action to clean the inside of heat exchanger pipes. The system includes a spoon-shaped rubber body and an abrasive layer of granular elements fixed to the rubber body by means of an adhesive film. Also in this case, the cleaning system shows the drawback to cause abrasion of the metal itself and besides to need a periodic maintenance.

The need was therefore felt to have available a method to obtain an easy removal of the calcar deposited on metal surfaces, without having the above mentioned drawbacks of the cleaning systems used in the prior art.

The Applicant has surprisingly and unexpectedly found that it is possible to solve the above technical problem using specific perfluoropolyether compounds to confer to metal substrata and their alloys anti-calcar properties.

An object of the invention is therefore the use in the treatment of metal substrata and their alloys, of mono- and bifunctional (per)fluoropolyether compounds having the following structures:

[R_{f}—CFY—L—O]ₘP(O)(O⁻Z⁺)₃₋ₘ (A)

(O⁻Z₊)₂P(O)[O—L—YFC—O—R_{f}—CFY—L—O—P(O)(O⁻Z₊)]_{m′}—[O—L—YFC—O—R_{f}—CFY—L—O]P(O)(O⁻Z₊)₂ (B)

R_{f}—CFY—L—W (C)

W—L—YFC—O—R_{f}—CFY—L—W (D)

wherein:

m′is an integer from 0 to 20, preferably from 0 to 4;

L is an organic group selected from —CH₂—(OCH₂CH₂)ₙ—, —CO—NR′—(CH₂)_{q}—, with R′=H or C₁-C₄ alkyl;

n=0-8, preferably 1-3, q=1-8, preferably 1-3;

Z=H, alkaline metal or NR₄ group with R=H or C₁-C₄ alkyl;

Y=F, CF₃;

m 1, 2, 3, preferably 1, 2;

W is a group —Si(R₁)_{α}(OR₂)_{3-α} with α=0, 1, 2, R₁ and R₂ equal to or different from each other are C₁-C₆ alkyl groups optionally containing one or more ether O, C₆-C₁₀ aryl groups, C₇-C₁₂ alkyl-aryl or aryl-alkyl groups;

Rf has a number average molecular weight in the range 350-8,000, preferably 500-3,000 and comprises repeating units having at least one of the following structures, statistically placed along the chain:

(CFXO), (CF₂CF₂O), (CF₂CF₂CF₂O), (CF₂CF₂CF₂CF₂O), (CR₄R₅CF₂CF₂O), (CF(CF₃)CF₂O), (CF₂CF(CF₃)O),

wherein

X=F, CF₃;

R₄ and R₅, equal to or different from each other, are selected from H, Cl, or perfluoroalkyl having from 1 to 4 carbon atoms.

In particular Rf can have one of the following structures:

1) —(CF₂O)_{a′}—(CF₂CF₂O)_{b′}—

with a′/b′ in the range 0.5-2, extremes included, a′ and b′ being integers such as to give the above molecular weight;

2) —(C₃F₆O)ᵣ—(C₂F₄O)_{b}—(CFXO)ₜ—

with r/b=0.5-2.0; (r+b)/t is comprised between 10-30, b, r and t being integers such as to give the above molecular weight, X has the above meaning;

3) —(C₃F₆O)_{r′}—(CFXO)_{t′}—

t′ can be 0;

when t′ is different from 0 then r′/t′ 10-30, r′ and t′ being integers such as to give the above molecular weight; X has the above meaning;

4) —(OCF₂CF(CF₃))_{z}—OCF₂(R′f)_{y}—CF₂O—(CF(CF₃)CF₂O)_{z}—

wherein z is an integer such that the molecular weight is the above one;

y is an integer between 0 and 1 and R′f is a fluoro-alkylene group having for example 1-4 carbon atoms;

5) —(OCF₂CF₂CR₄R₅)_{q}—OCF₂(R′f)_{y}—CF₂O—(CR₄R₅CF₂CF₂O)ₛ—

wherein:

q and s are integers such that the molecular weight is the above one;

R₄, R₅, R′f, y have the above meaning;

6) —(C₃F₆O)_{r′″}(CFXO)_{t′″}—OCF₂(R′f)_{y}—CF₂O(CF(CF₃)CF₂O)_{r′″}(CFXO)_{t′″}—

wherein r′″/t′″=10-30,

r′″ and t′″ being integers such as to give the above molecular weight;

R′f and y having the above meaning.

In the above formulas:

—(C₃F₆O)— can represent units of formula

—(CF(CF₃)CF₂O)— and/or —(CF₂CF(CF₃)O)—

In the structures (A) and (C) wherein the perfluoropolyether compound is monofunctional, the end group of R_{f} is of the T—O— type, wherein T is a (per)fluoroalkyl group selected from: —CF₃, —C₂F₅, —C₃F₇, —CF₂Cl, —C₂F₄Cl, —C₃F₆Cl; optionally one or two F atoms, preferably one, can be substituted by H.

Binary, ternary and quaternary mixtures of the above compounds (A), (B), (C) and (D) can also be used. Preferably mixtures of compounds (C) and (D) are used.

The mentioned fluoropolyethers are obtainable by well known processes of the prior art, see for example the following patents herein incorporated by reference: U.S. Pat. Nos. 3,665,041, 2,242,218, 3,715,378, and EP 239,123. The functionalized fluoropolyethers having a hydroxyl termination are obtained for example according to EP 148,482, U.S. Pat. No. 3,810,874.

The preparation of the monofunctional (per)fluoropolyether phosphates of structure (A) can be carried out by reacting the corresponding (per)fluoroalkylenoxides hydroxy-ended with POCl₃. To obtain the monoester derivative (m=1) it is necessary to use a molar ratio POCl₃/hydroxy-ended compound in the range 2/1-10/1, preferably 6/1-8/1. The reaction is carried out by slowly dropping the hydroxy-ended compound in POCl₃, at a temperature between 50° and 100° C., preferably between 70° and 80° C., eliminating the HCl vapours in a KOH trap. The POCl₃ excess is removed by distillation while the formed adduct is hydrolyzed by H₂O. The separation of the obtained compound is carried out by extraction with a suitable organic solvent, such as for example ethyl acetate. The compound of structure (A) with m=1 is separated from the organic phase according to known techniques, for example by solvent evaporation.

To obtain the biester derivative (m=2) of formula (A) one proceeds as in the monoester case with the difference that after the POCl₃ removal, the reaction adduct is further reacted with an equimolar amount of hydroxy-ended compound. Subsequently hydrolysis is carried out and one proceeds as above described.

To obtain the triester derivative (m=3) of formula (A) one proceeds as in the monoester case with the difference that after the POCl₃ removal, the reaction adduct is further reacted with a bimolar amount of hydroxy-ended compound. Subsequently hydrolysis is carried out and one proceeds as above described.

The preparation of the bifunctional (per)fluoropolyether phosphates of structure (B) can be carried out by reacting the corresponding (per)fluoroalkylenoxides di-hydroxy-ended with POCl₃. To obtain the derivative with m′=0, it is necessary to use a molar ratio POCl₃/di-hydroxy-ended compound in the range 4/1-20/1, preferably 12/1-16/1. The reaction is carried out by slowly dropping the hydroxy-ended compound in POCl₃, at a temperature in the range 50°-100° C., preferably 70°-80° C., eliminating the HCl vapours in a KOH trap. The POCl₃ excess is removed by distillation while the formed adduct is hydrolyzed by H₂O. The separation of compound (B) with m′=0 is carried out by extraction with a suitable organic solvent, such as for example ethyl acetate. The compound is separated from the organic phase according to known techniques, for example by solvent evaporation.

To obtain the compound of structure (B) with m′>0, one proceeds as in the case m′=0 with the difference that after the POCl₃ removal, the reaction adduct is further reacted with variable amounts of di-hydroxy-ended compound. Subsequently hydrolysis is carried out and the above described procedure is performed.

The (per)fluoropolyether silanes of structure (C) and (D) are known compounds, and can be prepared according to, for example, U.S. Pat. No. 4,094,911, U.S. Pat. No. 4,818,619.

The Applicant has surprisingly found that by using the (per)fluoropolyether compounds of the invention for the treatment of metals or their alloys, a coating having good anti-calcar properties, is obtained, i.e. the calcar present in a running water flow does not succeed in adhering to the metal surfaces when they are treated with the perfluoropolyther compounds of the invention. Also in the case of calcar deposit coming from stagnant water, the calcar is easily removable from the metal surface by simply using a water flow. The invention allows to avoid the use of abrasive systems, such as brushes, and of chemical systems such as acid solutions which can lead to corrosion phenomena of the metal surface.

The perfluoropolyether silanes of structures (C) and (D) are applied using formulations with solvent, solvent-water admixtures or prevailingly aqueous formulations. The solvents can be polar, for example alcohols and glycols, fluorinated solvents, for example perfluoropolyether, hydroperfluoropolyether and perfluorocarbon solvents, or hydrocarbon solvents. The concentration of the perfluoropolyether silanes present in the formulation can be in the range 0.01-15% by weight, preferably 0.1-5% by weight. In the formulation also a hydrolysis catalyst can be present, such as an acid or a base in a variable ratio by weight from 1/10 to 1/1 with the perfluoropolyether silane, preferably in the range 1/4-1/1. As acids the perfluoropolyether phosphates can be used, for example the compounds of structure (A) and (B), or other acids such as for example the acetic acid. However it is preferred to use as acid catalysts, those having a pKₐ comparable with that of the acetic acid to avoid the chemical attack on the metal. As bases ammonia and aliphatic or aromatic amines can be used. An amount of water such to favour the hydrolysis reactions and the condensation of the perfluoropolyether silanes can be introduced in the formulation.

The treatment can occur by using the usual application techniques such as for example dipping, spin-coating, spraying, padding and brushing. After the application of the formulation containing the perfluoropolyether silanes of structure (C) and (D) a thermal treatment of the surface can follow at a temperature in the range 60-250° C., preferably 80-200° C. for a time comprised betwen few minutes and 180 minutes, preferably between 10 and 30 minuti. Such thermal treatment allows a quick evaporation of the solvent and favours the further polycondensation of the perfluoropolyether silanes. When it is desired to avoid the thermal treatment it is generally necessary the presence of an acid or basic catalyst in the formulation. Besides in this case, it is necessary to wait for at least 24 hours to obtain the crosslinking of the compounds (C) and (D) of the invention.

The perfluoropolyether phosphates of structure (A) and (B) are applied using aqueous formulations or formulations having a polar solvent. The PFPE phosphates of structure (A) and (B) can be used both under the form of acids and as salts, for example ammonium salts. The formulation contains an amount by weight of perfluoropolyether phosphate in the range 0.1-10% by weight, preferably 0.5-5%. In this case no thermal treatment is necessary, unless one wants to speed up the evaporation of the solvent and/or water.

Examples of application of said anti-calcar treatments are in heat-exchangers, i.e. in the internal pipes of the exchangers wherein hot water flows, which tends to deposit calcar. As said, the calcar tends to form an internal layer which can partially obstruct the water flow, increasing the load losses and besides it strongly limits the thermal exchange between the heat source outside the pipe and the water inside the pipe.

Other metal substrata to which the perfluoropolyether compounds of the invention can be applied to confer anti-calcar properties, are the internal pipes of aqueducts, the metal part containing the water of the coffee-machines, the iron plates and the metal parts of taps, showers and sinks.

As said, the compounds of the invention minimize the calcar deposition on metal surfaces or allow an easy removal of the calcar deposited on metal surfaces, without substantially modifying the protective coating. In practice, the metal surfaces treated with the compounds of the invention maintain the anti-calcar properties in the time, even after a high number of deposition and removal cycles. Therefore from the industrial point of view the compounds of the invention can be used to treat the internal parts of the exchangers wherein running water continuously flows without having any calcar deposit on the exchanger surfaces. This represents a remarkable advantage since exchangers maintain unaltered their exchange efficiency.

Besides, it has been found by the Applicant that the compounds of the invention, preferably those of structure (C) and (D) can be used to obtain thin coatings on metal substrata having anticorrosive properties. Application examples are in particular in the treatment of metal surfaces having a low melting point alternatively to PTFE-based coatings. In fact PTFE-based coatings are carried out at very high temperatures at which metals tend easily to get deformed. With the compounds of the invention, these drawbacks do not occur since the treatments are carried out at much lower temperatures, and of the maximum order of 150°-200° C. in the case of crosslinking of the compounds (C) and (D) by thermal treatment. An example of anti-corrosive treatment is that which can be carried out on the metal parts of galvanic cells, for example electrodes. It has been noticed that the treatment with the compounds of the invention (C) and (D) can be carried out in very thin layers with respect to the conventionally used compounds. In the case of galvanic cells, there is not a substantial change of the galvanic cell efficiency compared with the case of untreated materials.

The present invention will be better illustrated by the following Examples, which have a merely indicative but not limitative purpose of the scope of the invention itself.

### EXAMPLES

Characterization

As metal substratum copper plates having 50×50 mm sizes are used.

The copper plates before the treatment with the fluorinated compounds of the invention are subjected to pickling using a hydrochloric acid solution at 5% by weight. Then washings are carried out with solvents, such as for example ethanol, hexane, to remove the impurities from the metal surface.

The plates are dipped for about 3 hours in a saturated calcium bicarbonate solution brought to the boiling temperature. Calcium carbonate (calcar) forms which tends to deposit on the copper plates. The formation of a white deposit on the metal is visually observed. The calcar presence on the surface is shown by a lowering of the contat angle values.

In the following Examples the calcar removal has been carried out by simple washing of the treated specimens with running water. Then the specimens are dried in a stove at the temperature of 100° C. for some minutes.

The removal of the calcar deposit from the copper plate is shown by the return to a high contact angle value towards water, typical of the presence on the surface of fluorinated compounds.

Contact Angle Measurement

To evaluate the adhesion of the formulation applied to the copper plate and the probable deposition/removal of calcar from the copper plate, static contact angle measurements towards water are carried out by the G10 (KRUSS) instrument at the temperature of 20° C.

It is known that the presence on the metal surface of fluorinated compounds is shown by high values of contact angle (higher than 100°). Threfore, the presence of calcar on the metal surface is indicated by a meaningful lowering of the contact angle values.

For each example, 3 values θ₁,θ₂,θ₃ relating to the static contact angle are indicated, having the following meaning:

θ₁=value of the contact angle before the calcar deposition on the copper plate;

θ₂=value of the contact angle after the calcar deposition on the copper plate;

θ₃=value of the contact angle after the washing with running water of the copper plate.

Corrosion Evaluation Method

Copper plates having 50×50 mm sizes are used as metal substratum.

The copper plates before the treatment with the compounds of the invention are pickled with hydrochloric acid at 5% by weight. Subsequently the plate washing is carried out as above described to remove possible impurities from the metal surface.

After drying in a stove at a temperature of about 100° C. for 10 minutes, the plates are treated with the compounds of the invention.

After the treatment, the plates are put in contact with air having a high humidity degree (relative humidity=80%) for a time equal to 24 hours and 1 month.

Then the aspect of the plates is evaluated and the residue corrosion degree is measured according to the ASTM Copper Strip Corrosion Standards (ASTM method D130/IP154).

### Example 1 (Comparative)

Untreated copper

A copper plate having 50×50 mm sizes is dipped into the above mentioned calcium bicarbonate solution without carrying out any pre-treatment with the compounds of the invention.

The values relating to the contact angle are shown in Table 1. The θ₃ value shows that the calcar once deposited is not removed by a simple washing with water.

### Example 2

A copper plate having 50×50 mm sizes is treated by dipping at a dipping rate equal to 0.526 mm/sec. with 30 ml of a formulation formed by:

1% by weight with respect to the total weight of the formulation of an admixture of perfluoropolyether silanes having structure (C) and (D) in a weight ratio 3/1:

Cl(C₃F₆O)ₚCF₂—CONH(CH₂)₃Si(OC₂H₅)₃ wherein p=2-5 (C)

(C₂H₅O)₃Si(CH₂ )₃HNOC—CF₂O(CF₂CF₂O)ₘ(CF₂O)ₙCF₂—CONH(CH₂)₃Si(OC₂H₅)₃ wherein n=2-4, m=2-6 (D)

94% by weight of isopropyl alcohol;

4% by weight of water;

1% by weight of acetic acid as hydrolysis catalyst.

The copper specimen is dipped in the formulation for 10 minutes and subsequently subjected to the following two-phase thermal treatment:

1) heating at 65° C. for 40 minutes;

2) heating at 160° C. for 12 minutes.

After the treatment with the fluorinated compounds of the invention, the copper plate is dipped in the above calcium bicarbonate solution.

The values relating to the contact angle are shown in Table 1. The θ₃=θ₁ value shows that the calcar once deposited is effectively removed by a simple washing with water.

### Example 3

A copper plate having 50×50 mm sizes is treated by dipping at a dipping rate equal to 0.526 mm/sec with 30 ml of a formulation formed by:

5% by weight with respect to the total weight of the formulation of an admixture of perfluoropolyether silanes having structure (C) and (D) in a weight ratio 3/1:

Cl(C₃F₆O)ₚCF₂—CONH(CH₂)₃Si(OC₂H₅)₃ wherein p=2-5 (C)

(C₂H₅O)₃Si(CH₂)₃HNOC—CF₂O(CF₂CF₂O)ₘ(CF₂O)ₙCF₂—CONH(CH₂)₃Si(OC₂H₅)₃ wherein n=2-4, m=2-6 (D)

70% by weight of isopropyl alcohol;

20 by weight of water;

5% by weight of acetic acid as hydrolysis catalyst.

The copper specimen is dipped in the formulation for 10 minutes and subsequently subjected to the following two-phase thermal treatment:

1) heating at 65° C. for 40 minutes;

2) heating at 160° C. for 12 minutes.

After the treatment, the copper plate is dipped in the above calcium bicarbonate solution.

The values relating to the contact angle are shown in Table 1. The θ₃=θ₁ value shows that the calcar once deposited is effectively removed by a simple washing with water.

### Example 4

A copper plate having 50×50 mm sizes is treated by dipping at a dipping rate equal to 0.526 mm/sec with 30 ml of a formulation formed by:

5% by weight with respect to the total weight of the formulation of a perfluoropolyether silane having structure (D):

(C₂H₅O)₃Si(CH₂)₃HNOC—CF₂O(CF₂CF₂O)ₘ(CF₂O)ₙCF₂—CONH(CH₂)₃Si(OC₂H₅)3 wherein n=2-4, m=2-6 (D)

75% by weight of isopropyl alcohol;

19% by weight of water;

1% by weight of acetic acid as hydrolysis catalyst.

The copper specimen is dipped in the formulation for 10 minutes and subsequently subjected to the following two-phase thermal treatment:

1) heating at 65° C. for 40 minutes;

2) heating at 16° C. for 12 minutes.

After the treatment with the fluorinated compounds of the invention, the copper plate is dipped in the above calcium bicarbonate solution.

The values relating to the contact angle are shown in Table 1. The θ₃˜θ₁ value shows that the calcar once deposited is effectively removed by a simple washing with water.

### Example 5

A copper plate having 50×50 mm sizes is treated by dipping at a dipping rate equal to 0.526 mm/sec with 30 ml of a formulation formed by:

5% by weight with respect to the total weight of the formulation of a perfluoropolyether silane having structure (C):

Cl(C₃F₆O)ₚCF₂—CONH(CH₂)₃Si(OC₂H₅)₃ wherein p=2-5 (C)

65% by weight of isopropyl alcohol;

29% by weight of water;

1% by weight of acetic acid as hydrolysis catalyst.

The copper specimen is dipped in the formulation for 10 minutes and subsequently subjected to the following two-phase thermal treatment:

1) heating at 65° C. for 40 minutes;

2) heating at 160° C. for 12 minutes.

After the treatment with the fluorinated compounds of the invention, the copper plate is dipped in the above calcium bicarbonate solution.

The values relating to the contact angle are shown in Table 1. The θ₃˜θ₁ value shows that the calcar once deposited is effectively removed by a simple washing with water.

### Example 6

A copper plate having 50×50 mm sizes is treated by dipping at a dipping rate equal to 0.526 mm/sec with 30 ml of a formulation formed by:

1% by weight with respect to the total weight of the formulation of a bifunctional perfluoropolyether (PFPE) phosphate which is a mixture of the structures reported below:

(HO)₂(O)PO(C₂H₄O)ₚCH₂CF₂O(C₂F₄O)ₙ(CF₂O)ₘCF₂CH₂(OC₂H₄)ₚOP(O)(OH)₂ 1)

[(HO)₂(O)PO(C₂H₄O)ₚCH₂CF₂O(C₂F₄O)ₙ(CF₂O)ₘCF₂CH₂(OC₂H₄)ₚO]₂P(O)OH 2)

wherein p=1-4, n=2-4, m=2-6

wherein the compound 1) represents the 90% by moles and the compound 2) the 10% by moles;

10% by weight of isopropyl alcohol;

89% by weight of water.

The copper specimen is dipped in the formulation for 10 minutes and subsequently heated at the temperture of 160° C. for 12 minutes.

After the treatment with the fluorinated compounds of the invention, the copper plate is dipped in the above calcium bicarbonate solution.

The values relating to the contact angle are shown in Table 1. The θ₃˜θ₁ value shows that the calcar once deposited is effectively removed by a simple washing with water.

### Example 7

A copper plate having 50×50 mm sizes is treated by dipping at a dipping rate equal to 0.526 mm/sec with 30 ml of a formulation formed by:

5% by weight with respect to the total weight of the formulation of a bifunctional perfluoropolyether (PFPE) phosphate which is a mixture of the structures reported below:

(HO)₂(O)PO(C₂H₄O)ₚCH₂CF₂O(C₂F₄O)ₙ(CF₂O)ₘCF₂CH₂(OC₂H₄)ₚOP(O)(OH)₂ 1)

[(HO)₂(O)PO(C₂H₄O)ₚCH₂CF₂O(C₂F₄O)ₙ(CF₂O)ₘCF₂CH₂(OC₂H₄)ₚO]₂P(O)OH 2)

wherein p=1-4, n=2-4, m=2-6

wherein the compound 1) represents the 90% by moles and the compound 2) the 10% by moles;

70% by weight of isopropyl alcohol;

25% by weight of water.

The copper specimen is dipped in the formulation for 10 minutes and subsequently heated at the temperature of 160° C. for 12 minutes.

After the treatment with the fluorinated compounds of the invention, the copper plate is dipped in the above calcium bicarbonate solution.

The values relating to the contact angle are shown in Table 1. The θ₃=θ₁ value shows that the calcar once deposited is effectively removed by a simple washing with water.

### Example 8

A copper plate having 50×50 mm sizes is treated by dipping at a dipping rate equal to 0.526 mm/sec with 30 ml of a formulation formed by:

3.3% by weight with respect to the total weight of the formulation of an ammonium salt of bifunctional perfluoropolyether (PFPE) phosphate which is a mixture of the structures reported below:

(NH₄O)₂(O)PO(C₂H₄O)ₚCH₂CF₂O(C₂F₄O)ₙ(CF₂O)ₘCF₂CH₂(OC₂H₄)ₚ—OP(O)(ONH₄)₂ 1)

[(NH₄O)₂(O)PO(C₂H₄O)ₚCH₂CF₂O(C₂F₄O)ₙ(CF₂O)ₘCF₂CH₂(OC₂H₄)ₚO]₂—P(O)ONH₄ 2)

wherein p=1-4, n=2-4, m=2-6

wherein the compound 1) represents the 90% by moles and the compound 2) the 10% by moles;

96.7% by weight of water.

The copper specimen is dipped in the formulation for 10 minutes and subsequently heated at the temperature of 160° C. for 12 minutes.

After the treatment with the fluorinated compounds of the invention, the copper plate is dipped in the above calcium bicarbonate solution.

The values relating to the contact angle are shown in Table 1. The θ₃˜θ₁ value shows that the calcar once deposited is effectively removed by a simple washing with water.

### Example 9

A copper plate having 50×50 mm sizes is treated by dipping at a dipping rate equal to 0.526 mm/sec with 30 ml of a formulation formed by:

1% by weight with respect to the total weight of the formulation of a bifunctional perfluoropolyether (PFPE) phosphate which is a mixture of the structures reported below:

(HO)₂(O)PO(C₂H₄O)ₚCH₂CF₂O(C₂F₄O)ₙ(CF₂O)ₘCF₂CH₂(OC₂H₄)ₚ—OP(O)(OH)₂ 1)

[(HO)₂(O)PO(C₂H₄O)ₚCH₂CF₂O(C₂F₄O)ₙ(CF₂O)ₘCF₂CH₂(OC₂H₄)ₚO]₂—P(O)OH 2)

wherein p=1-4, n=2-4, m=2-6

wherein the compound 1) represents the 60% by moles and the compound 2) the 40% by moles;

99% by weight of isopropyl alcohol.

The copper specimen is dipped in the formulation for 10 minutes and subsequently heated at the temperature of 160° C. for 12 minutes.

After the treatment with the fluorinated compounds of the invention, the copper plate is dipped in the above calcium bicarbonate solution.

The values relating to the contact angle are shown in Table 1. The θ₃˜θ₁ value shows that the calcar once deposited is effectively removed by a simple washing with water.

TABLE 1

| | θ₁ | θ₂ | θ₃ |
|---|---|---|---|
| Example 1 (Comp) | 78° | 40° | 54° |
| Example 2 | 110° | 80° | 110° |
| Example 3 | 110° | 92° | 110° |
| Example 4 | 103° | 70° | 100° |
| Example 5 | 112° | 75° | 110° |
| Example 6 | 113° | 60° | 109° |
| Example 7 | 115° | 90° | 110° |
| Example 8 | 116° | 68° | 110° |
| Example 9 | 104° | 70° | 100° |

### Example 10 (Comparative)

Untreated Copper

After the above washing to remove possible impurities, the copper plates are put in contact with air having a high humidity degree (relative humidity=80%).

One proceeds to the visual evaluation of the plate to point out corrosion according to the ASTM D130/IP154 standard after t=1 day and t=1 month. The results are reported in Table 2.

### Example 11

A copper plate having 50×50 mm sizes is treated by dipping at a dipping rate equal to 0.526 mm/sec with 30 ml of a formulation formed by:

1% by weight with respect to the total weight of the formulation of a mixture of perfluoropolyether silanes having structure (C) and (D) in a weight ratio 3/1:

Cl(C₃F₆O)ₚCF₂—CONH(CH₂)₃Si(OC₂H₅)₃ wherein p=2-5 (C)

C₂H₅O)₃Si(CH₂)₃HNOC—CF₂O(CF₂CF₂O)ₘ(CF₂O)ₙCF₂—CONH(CH₂)₃Si(OC₂H₅)₃ wherein n=2-4, m=2-6 (D)

94% by weight of isopropyl alcohol;

4% by weight of water;

1% by weight of acetic acid as hydrolysis catalyst.

The copper specimen is dipped in the formulation for 10 minutes and subsequently subjected to the following two-phase thermal treatment:

1) heating at 65° C. for 40 minutes;

2) heating at 160° C. for 12 minutes.

After the treatment with the perfluoropolyether compounds of the invention, the copper plates are put in contact with air having a high humidity degree (relative humidity=80%).

One proceeds to the visual evaluation of the plate to point out corrosion according to the above ASTM standard after 24 hours and 1 month. The results are reported in Table 2.

### Example 12

A copper plate having 50×50 mm sizes is treated by dipping at a dipping rate equal to 0.526 mm/sec with 30 ml of a formulation formed by:

5% by weight with respect to the total weight of the formulation of a mixture of perfluoropolyether silanes having structure (C) and (D) in a weight ratio 3/1:

Cl(C₃F₆O)ₚCF₂—CONH(CH₂)₃Si(OC₂H₅)₃ wherein p=2-5 (C)

(C₂H₅O)₃Si(CH₂)₃HNOC—CF₂O(CF₂CF₂O)ₘ(CF₂O)ₙCF₂—CONH(CH₂)₃Si(OC₂H₅)3 wherein n=2-4, m=2-6 (D)

70% by weight of isopropyl alcohol;

20% by weight of water;

5% by weight of acetic acid as hydrolysis catalyst.

The copper specimen is dipped in the formulation for 10 minutes and subsequently subjected to the following two-phase thermal treatment:

1) heating at 65° C. for 40 minutes;

2) heating at 160° C. for 12 minutes.

After the treatment with the perfluoropolyether compounds of the invention, the copper plates are put in contact with air having a high humidity degree (relative humidity=80%).

One proceeds to the visual evaluation of the plate to point out corrosion according to the above ASTM standard after 24 hours and 1 month. The results are reported in Table 2.

### Example 13

A copper plate having 50×50 mm sizes is treated by dipping at a dipping rate equal to 0.526 mm/sec with 30 ml of a formulation formed by:

1% by weight with respect to the total weight of the formulation of a bifunctional perfluoropolyether (PFPE) phosphate which is a mixutre of the structures reported below:

(HO)₂(O)PO(C₂H₄O)ₚCH₂CF₂O(C₂F₄O)ₙ(CF₂O)ₘCF₂CH₂(OC₂H₄)ₚOP(O)(OH)₂ 1)

[(HO)₂(O)PO(C₂H₄O)ₚCH₂CF₂O(C₂F₄O)ₙ(CF₂O)ₘCF₂CH₂(OC₂H₄)ₚO]₂P(O)OH 2)

wherein p=1-4, n=2-4, m=2-6

wherein the compound 1) represent the 90% by moles and the compound 2) the 10% by moles;

10% by weight of isopropyl alcohol;

89% by weight of water.

The copper specimen is dipped in the formulation for 10 minutes and subsequently heated at the temperature of 160° C. for 12 minutes.

After the treatment with the perfluoropolyether compounds of the invention, the copper plates are put in contact with air having a high humidity degree (relative humidity=80%).

One proceeds to the visual evaluation of the plate to point out corrosion according to the above ASTM standard after 24 hours and 1 month. The results are reported in Table 2.

### Example 14

A copper plate having 50×50 mm sizes is treated by dipping at a dipping rate equal to 0.526 mm/sec with 30 ml of a formulation formed by:

5% by weight with respect to the total weight of the formulation of a bifunctional perfluoropolyether (PFPE) phosphate which is a mixutre of the structures reported below:

(HO)₂(O)PO(C₂H₄O)ₚCH₂CF₂O(C₂F₄O)ₙ(CF₂O)ₘCF₂CH₂(OC₂H₄)ₚOP(O)(OH)₂ 1)

[(HO)₂(O)PO(C₂H₄₀)ₚCH₂CF₂O(C₂F₄O)ₙ(CF₂O)ₘCF₂CH₂(OC₂H₄)ₚO]₂P(O)OH 2)

wherein p=1-4, n 2-4, m=2-6

wherein the compound 1) represents the 90% by moles and the compound 2) the 10% by moles;

70% by weight of isopropyl alcohol;

25% by weight of water.

The copper specimen is dipped in the formulation for 10 minutes and subsequently heated at the temperature of 160° C. for 12 minutes.

After the treatment with the perfluoropolyether compounds of the invention, the copper plates are put in contact with air having a high humidity degree (relative humidity=80%).

One proceeds to the visual evaluation of the plate to point out corrosion according to the above ASTM standard after 24 hours and 1 month. The results are reported in Table 2.

### Example 15

Example 11 has been repeated with the variation that the copper plate before being put in contact with humid air, is dipped in a hydrochloric acid solution at 5% by weight for about one hour. It is noticed that this further corrosive phase does not modify the results obtained in Example 11.

TABLE 2

| | after 24 hours | after 1 month |
|---|---|---|
| Example 10 (Comp.) | 3b | 4a |
| Example 11 | 1b | 2a |
| Example 12 | 0 | 1a |
| Example 13 | 2a | 3b |
| Example 14 | 2a | 3b |
| Example 15 | 1b | 2a |

0 = no variation
1b = light corrosion
2a = moderate corrosion
3b = strong corrosion
4a = total corrosion

1. Use in the treatment of metal substrata and their alloys, of mono- and bifunctional (per)fluoropolyether compounds having the following structures:
[R_{f}—CFY—L—O]ₘP(O)(O⁻Z⁺)₃₋ₘ (A)
(O⁻Z⁺)₂P(O)[O—L—YFC—O—R_{f}—CFY—L—O—P(O)(O⁻Z⁺)]_{m′}—[O—L—YFC—O—R_{f}—CFY—L—O]P(O)(O⁻Z⁺)₂ (B)
R_{f}—CFY—L—W (C)
W—L—YFC—O—R_{f}—CFY—L—W (D)
wherein:
m′ is an integer from 0 to 20, preferably from 0 to 4;
L is an organic group selected from —CH₂—(OCH₂CH₂)ₙ—, —CO—NR′—(CH₂)_{q}—, with R′=H or C₁-C₄ alkyl;
n=0-8, preferably 1-3, q=1-8, preferably 1-3;
Z=H, alkaline metal or NR₄ group with R=H or C₁-C₄ alkyl; Y=F, CF₃;
m=1, 2, 3, preferably 1, 2;
W is a group —Si(R₁)_{α}(OR₂)_{3-α} with α=0, 1, 2, R₁ and R₂ equal to or different from each other are C₁-C₆ alkyl groups optionally containing one or more ether O, C₆-C₁₀ aryl groups, C₇-C₁₂ alkyl-aryl or aryl-alkyl groups;
Rf has a number average molecular weight in the range 350-8,000, preferably 500-3,000 and comprises repeating units having at least one of the following structures, statistically placed along the chain:
(CFXO), (CF₂CF₂O), (CF₂CF₂CF₂O), (CF₂CF₂CF₂CF₂O), (CR₄R₅CF₂CF₂O), (CF(CF₃)CF₂O), (CF₂CF(CF₃)O),
wherein
X=F, CF₃;
R₄ and R₅, equal to or different from each other, are selected from H, Cl, or perfluoroalkyl having from 1 to 4 carbon atoms.

2. Use in the treatment of metal substrata according to claim 1, wherein Rf is selected from the following structures:
1) —(CF₂O)ₐ, —(CF₂CF₂O)_{b′}—
with a′/b′ in the range 0.5-2, extremes included, a′ and b′ being integers such as to give the above molecular weight;
2) —(C₃F₆O)ᵣ—(C₂F₄O)_{b}—(CFXO)ₜ—
with r/b=0.5-2.0; (r+b)/t is comprised between 10-30, b, r and t being integers such as to give the above molecular weight, X has the above meaning;
3) —(C₃F₆O)_{r′}—(CFXO)^{t′}—
t′ can be 0;
when t′ is different from 0 then r′/t′=10-30,
r′ and t′ being integers such as to give the above molecular weight; X has the above meaning;
4) —(OCF₂CF(CF₃))_{z}—OCF₂(R′f)_{y}—CF₂O—(CF(CF₃)CF₂O)_{z}—
wherein z is an integer such that the molecular weight is the above one;
y is an integer between 0 and 1 and R′f is a fluoroalkylene group having for example 1-4 carbon atoms;
5) —(OCF₂CF₂CR₄R₅)_{q}—OCF₂(R′f)_{y}—CF₂O—(CR₄R₅CF₂CF₂O)—
wherein:
q and s are integers such that the molecular weight is the above one;
R₄, R₅, R′f, y have the above meaning;
6) —(C₃F₆O)_{r′″}(CFXO)_{t′″}—OCF₂(R′f)_{y}—CF₂O(CF(CF₃)CF₂O)_{r′″}(CFXO)_{t′″}—
wherein r′″/t′″=10-30,
r′″ and t′″ being integers such as to give the above molecular weight;
R′f and y having the above meaning.

3. Use in the treatment of metal substrata according to claims 1-2, wherein in the compounds of structure (A) and (C) the end group of R_{f} is of the T—O— type, wherein T is a (per)fluoroalkyl group selected from: —CF₃, —C₂F₅, —C₃F₇, —CF₂Cl, —C₂F₄Cl, —C₃F₆Cl; optionally one or two F atoms, preferably one, can be substituted by H.

4. Use in the treatment of metal substrata according to claims 1-3, wherein a mixture of compounds (C) and (D) is used.

5. Use in the treatment of metal substrata according to claims 1-4, wherein the treatment is made by dipping, spin-coating, spraying, padding or brushing.

6. Use in the treatment of metal substrata according to claims 1-5, wherein the perfluoropolyether compounds of structure (C) and (D) are applied using formulations with solvent, solvent-water mixtures or prevailingly aqueous formulations.

7. Use in the treatment of metal substrata according to claim 6, wherein the concentration of the perfluoropolyether compounds of structure (C) and (D) in the formulation is in the range 0.01-15% by weight, preferably 0.1-5% by weight.

8. Use in the treatment of metal substrata according to claims 1-5, wherein the perfluoropolyether compounds of structure (A) and (B) are applied using aqueous formulations or formulations having a polar solvent.

9. Use in the treatment of metal substrata according to claim 8, wherein the formulation contains an amount by weight of perfluoropolyether compound of structure (A) and (B) in the range 0.1-10% by weight, preferably 0.5-5%.

10. Use in the treatment of metal substrata and their alloys to confer anti-corrosive properties of the mono- and bifunctional (per)fluoropolyether compounds of claims 1-9.

11. Use according to claim 10, wherein the perfluoropolyether compounds have structure (C) and (D).
